(19) United States
(12) Patent Application Publication
(10) Pub. No.: US 2022/0390939 A1
(43) Pub. Date: Dec. 8, 2022

(54) INTEGRATED CONTROL DEVICE FOR AUTONOMOUS VEHICLE

(71) Applicants: Hyundai Motor Company, Seoul (KR); Kia Corporation, Seoul (KR)

(72) Inventor: Eun Sik KIM, Gwangmyeong-si (KR)

(73) Assignees: Hyundai Motor Company, Seoul (KR); Kia Corporation, Seoul (KR)

(21) Appl. No.: 17/490,028

(22) Filed: Sep. 30, 2021

(30) Foreign Application Priority Data
Jun. 2, 2021 (KR) 1020210071662

(51) Int. Cl. G05D 1/00; B60W 50/08; B60W 60/00

(52) U.S. Cl. CPC G05D 1/0016; G05D 1/0061; B60W 50/082; B60W 60/0053; G05D 2201/0213; B60W 2050/0074

(57) ABSTRACT

An integrated control device provided on an autonomous vehicle may include an operating portion by which the acceleration, braking, steering, and shifting operations are input and a core controller coupled to the operating portion to control the acceleration, braking, steering, and shifting operations. A user selects a single operating portion from among a plurality of operating portions of various types according to his or her preference and couples the core controller to the selected operating portion for use.

### CROSS REFERENCE TO RELATED APPLICATION

The present application claims priority to Korean Patent Application No. 10-2021-0071662, filed Jun. 2, 2021, the entire contents of which is incorporated herein for all purposes by this reference.

### BACKGROUND OF THE INVENTION

### Field of the Invention

The present invention generally relates to an integrated control device for an autonomous vehicle, and more particularly, to a technology of an integrated control device provided on an autonomous vehicle to enable a user to directly operate the vehicle when autonomous driving mode is switched to manual driving mode.

### Description of Related Art

An autonomous vehicle is a smart vehicle to which autonomous driving technology is applied to enable the vehicle to travel to a destination without requiring a driver to directly operate the steering wheel, the accelerator pedal, the brake pedal, and the like.

When autonomous driving situations are implemented universally, a driver may select one from manual driving mode in which the driver directly operates a vehicle and autonomous driving mode in which the vehicle autonomously travels to a destination.

In an emergency situation occurring during autonomous driving of a vehicle, one of passengers of the vehicle must manually drive the vehicle. In this regard, the vehicle must be provided with a device allowing a user to drive the vehicle in manual driving mode.

For example, there are some cases in which a vehicle manager operates a vehicle using a control device used in a game console, such as a joystick, in manual driving mode. However, a plurality of button, lever, and toggle switches is provided in a complicated arrangement on a single joystick device. Thus, as drawbacks, such a control device is difficult and inconvenient to control, and there is the possibility of misoperation.

Furthermore, a user may perform, for example, acceleration, braking, steering, and shifting operations using an integrated control device of the related art. In the present case, a printed circuit board (PCB) of the control device transfers resultant operation signals to a controller area network (CAN) communication unit of the control device to generate CAN signals. The CAN communication unit of the control device also transmits the CAN signal to a CAN communication unit provided on the vehicle through wiring (e.g., a cable). The CAN communication unit of the vehicle receives the CAN signal transmitted from the CAN communication unit of the control device and transfers the received CAN signal to a controller provided on the vehicle. Accordingly, the controller provided on the vehicle respectively controls actuators for implementing acceleration, braking, steering, and shifting so that acceleration, braking, steering, and shifting functions are performed.

Accordingly, the integrated control device of the related art is configured such that signals are transmitted and received using the CAN communication unit on the integrated control device and the vehicle-side CAN communication unit. The integrated control device of the related art has drawbacks, such as a complicated configuration, high costs, low responsiveness caused by the conversion of CAN signals.

The information disclosed in this Background of the Invention section is only for enhancement of understanding of the background of the invention and may not be taken as an acknowledgement or any form of suggestion that this information forms the prior art already known to a person skilled in the art.

### BRIEF SUMMARY

Various aspects of the present invention are directed to providing an integrated control device provided on an autonomous vehicle to enable a user to directly operate the vehicle when autonomous driving mode is switched to manual driving mode. The integrated control device has a configuration including an operating portion by which acceleration, braking, steering, and shifting operations are input and a core controller coupled to the operating portion to control the acceleration, braking, steering, and shifting operations. Since the use of signal-transferring controller area network (CAN) communication units may be excluded, the simplification of the configuration and the reduction of costs may be promoted and the responsiveness of signals may be significantly improved.

The present invention is also intended to provide a configuration in which the operating portion is provided as a plurality of portions of various types and the core controller is provided as a single core controller. Thus, the user may select a single operating portion according to his or her preference and couple the core controller to the selected operating portion for use. The diversification of the operating portion may advantageously improve the convenience of operation and merchantability.

In various aspects of the present invention, there is provided an integrated control device provided on an autonomous vehicle to enable a user to operate the vehicle when autonomous driving mode is switched to manual driving mode. The integrated control device may include: an operating portion including an acceleration switch, a braking switch, a steering switch, and a shifting switch; and a core controller configured to be used in concert with the operating portion and perform control operations to transmit signals of acceleration, braking, steering, and shifting to the vehicle through wiring when at least one of the acceleration switch, the braking switch, the steering switch, and the shifting switch provided on the operating portion is operated.

The operating portion may include a plurality of operating portions of various types depending on positions and operating methods of the switches, and the core controller includes a single core controller such that the user may select one operating portion from among the plurality of operating portions and couple the core controller to the selected operating portion for use.

Each of the acceleration switch and the braking switch may include a button switch, the steering switch includes a dial switch or a lever switch, and the shifting switch includes a button switch or a toggle switch.

The operating portion may include a first operating portion provided on a first side, a second operating portion disposed provided on a second side and in parallel to the first operating portion, and a connecting portion connecting the first operating portion and the second operating portion. The acceleration switch and the braking switch may be disposed on the first operating portion, and the steering switch is disposed on the second operating portion, and the shifting switching is disposed on the connecting portion.

The operating portion may include an operating portion housing to which the acceleration switch, the braking switch, the steering switch, and the shifting switch are coupled and an operating portion PCB configured to process signals from the switches. The core controller may include a core controller housing coupled to the operating portion housing and a core controller PCB connected to the operating portion PCB to process the signals.

The operating portion housing may include a docking recess opened through one side thereof. The operating portion and the core controller may be coupled to each other, with the core controller housing being inserted into the docking recess.

The operating portion housing may further include guide protrusions provided on right and left side surfaces of the docking recess to extend in longitudinal directions of the side surfaces. The core controller housing may include guide grooves provided on first and second side surfaces of the core controller housing to extend in longitudinal directions of the first and second side surfaces of the core controller housing, such that, when the core controller housing is inserted into the docking recess, the guide protrusions are inserted into the guide grooves.

The operating portion housing may further include locking guides provided on an entrance of the docking recess and supported by return springs. The locking guides may include a pair of locking guides and protrude into the docking recess in opposite directions. When the insertion of core controller housing into the docking recess is completed, the pair of locking guides may support a rear surface of the core controller housing, preventing the core controller housing from being detached from the docking recess.

The operating portion PCB and the core controller PCB may include connectors, respectively, by which the operating portion PCB and the core controller PCB are coupled to each other.

The integrated control device may further include a display provided on the core controller to display information regarding the switches being operated and information regarding driving of the vehicle.

The core controller detached from the operating portion may be inserted into and stored in a vehicle-side receptacle.

The operating portion may have a ‘U’-shaped structure, and the core controller may be inserted into a recess of the ‘U’-shaped structure to be coupled to the operating portion.

The integrated control device configured for an autonomous vehicle according to various exemplary embodiments of the present invention has a configuration including the operating portion by which the acceleration, braking, steering, and shifting operations are input and the core controller coupled to the operating portion to control the acceleration, braking, steering, and shifting operations. When the user operates the switches of the operating portion, resultant switch signals are transferred to the core controller. Under the control of the core controller, the acceleration, braking, steering, and shifting actuators located on the vehicle side are operated to perform the acceleration, braking, steering, and shifting functions of the vehicle. Accordingly, the present invention may exclude the use of signal-transferring CAN communication units, advantageously promoting the simplification of the configuration and the reduction of costs and significantly improving the responsiveness of signals.

Furthermore, in the integrated control device according to various exemplary embodiments of the present invention, the operating portion is provided as a plurality of portions of various types depending on the position and the operating method of the switches, whereas the core controller performing the control operations may be provided as a single core controller. Thus, the user may select a single operating portion according to his or her preference and couple the core controller to the selected operating portion for use. The diversification of the operating portion may advantageously improve the convenience of operation and merchantability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a conceptual view exemplarily illustrating an integrated control device provided on an autonomous vehicle according to various exemplary embodiments of the present invention;

FIG. 2 is a perspective view exemplarily illustrating a coupled state of the first-type operating portion and the core controller according to various exemplary embodiments of the present invention;

FIG. 3 is a perspective view exemplarily illustrating a coupled state of the second-type operating portion and the core controller according to various exemplary embodiments of the present invention;

FIG. 4 is a perspective view exemplarily illustrating a coupled state of the third-type operating portion and the core controller according to various exemplary embodiments of the present invention;

FIG. 5 is a perspective view exemplarily illustrating a decoupled state of the operating portion and the core controller according to various exemplary embodiments of the present invention;

FIG. 6 and FIG. 7 are plan views exemplarily illustrating the operating portion and the core controller according to various exemplary embodiments of the present invention;

FIG. 8 is a plan view exemplarily illustrating a coupled state of the operating portion and the core controller according to various exemplary embodiments of the present invention; and

FIG. 9 is a conceptual view exemplarily illustrating the storage of the core controlled in a vehicle-side receptacle.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Specific structural and functional descriptions of embodiments of the present invention disclosed herein are only for illustrative purposes of the exemplary embodiments of the present invention. The present invention may be embodied in various forms without departing from the spirit and significant characteristics of the present invention. Therefore, the exemplary embodiments of the present invention are disclosed only for illustrative purposes and should not be construed as limiting the present invention.

Reference will now be made in detail to various embodiments of the present invention, specific examples of which are illustrated in the accompanying drawings and described below, since the exemplary embodiments of the present invention may be variously modified in various forms. While the present invention will be described in conjunction with exemplary embodiments thereof, it is to be understood that the present description is not intended to limit the present invention to those exemplary embodiments. On the other hand, the present invention is directed to cover not only the exemplary embodiments of the present invention, but also various alternatives, modifications, equivalents, and other embodiments which may be included within the spirit and scope of the present invention as defined by the appended claims.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it may be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to”, should be construed in the same way.

The terminology used herein is for the purpose of describing various exemplary embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in the exemplary embodiment, specify the presence of stated features, integers, steps, operations, elements, components, and/or combinations thereof but do not preclude the presence or addition of one or more other features, integers, steps, operations, elements, components, and/or combinations thereof

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present invention, and will not be interpreted in an idealized or overly formal sense unless expressly so defined herein.

A control unit (i.e., a controller) according to exemplary forms of the present invention may be implemented through a non-volatile memory configured to store algorithm configured to control the operations of various components of the vehicle or data related to software instructions reproducing the algorithm, and a processor configured to perform operations described below using the data stored in the memory. Here, the memory and the processor may be implemented as separate chips. Alternatively, the memory and the processor may be implemented as a single chip integrated with each other. The processor may take the form of one or more processors.

A control unit (i.e., a controller) according to exemplary embodiments of the present invention may be implemented using an algorithm configured to control the operations of a variety of components of a vehicle or a non-volatile memory configured to store data regarding software instructions reproducing the algorithm and a processor configured to execute operations described below using the data stored in the memory. The memory and the processor may be implemented as respective chips. Alternatively, the memory and the processor may be implemented as a single integrated chip. The processor may be provided as one or more processors.

Hereinafter, an integrated control device for an autonomous vehicle according to exemplary embodiments of the present invention will be described with reference to the accompanying drawings.

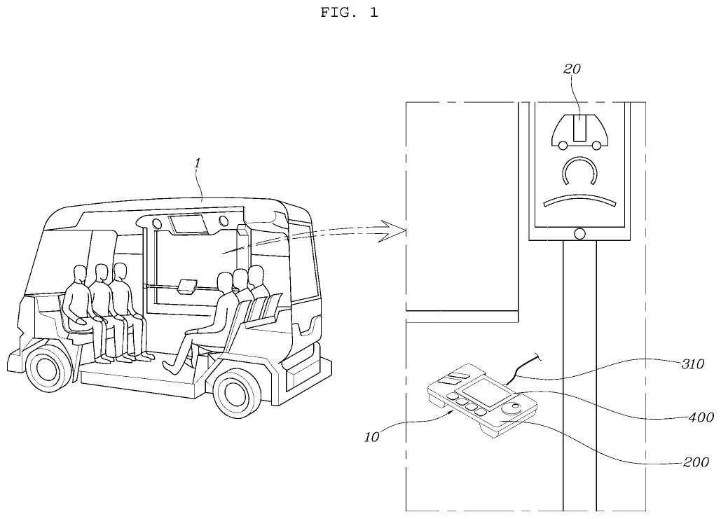

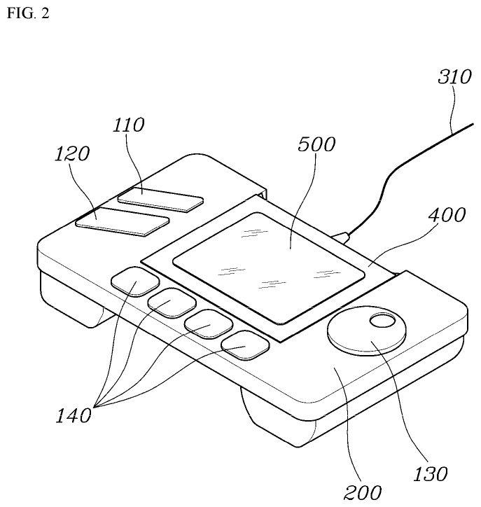

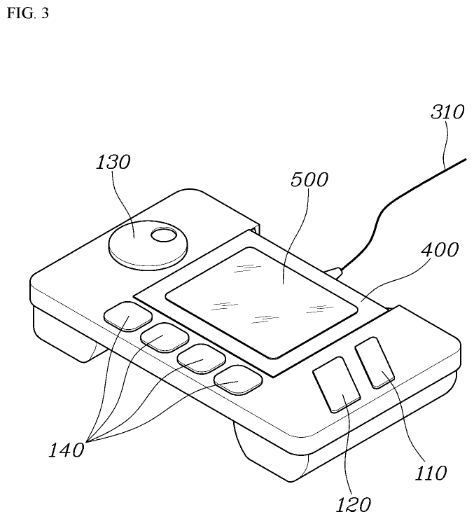

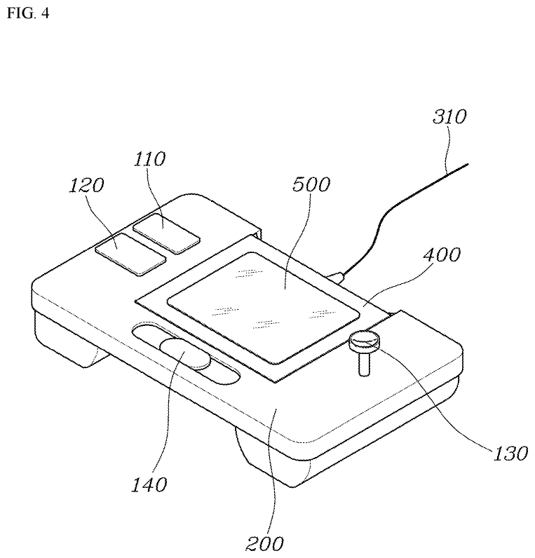

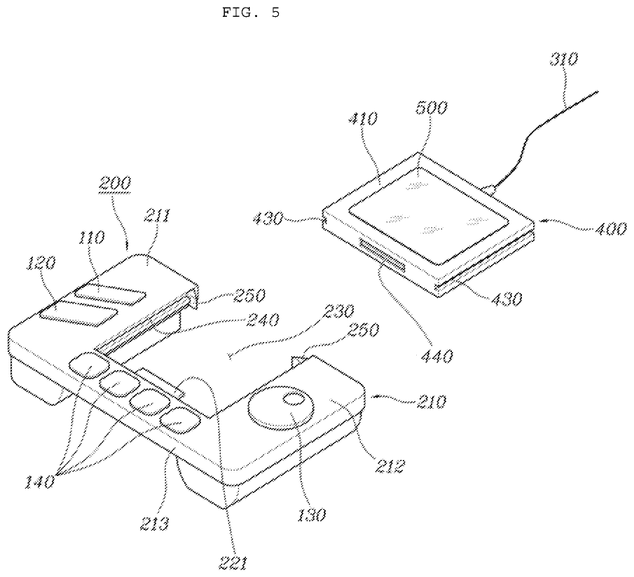

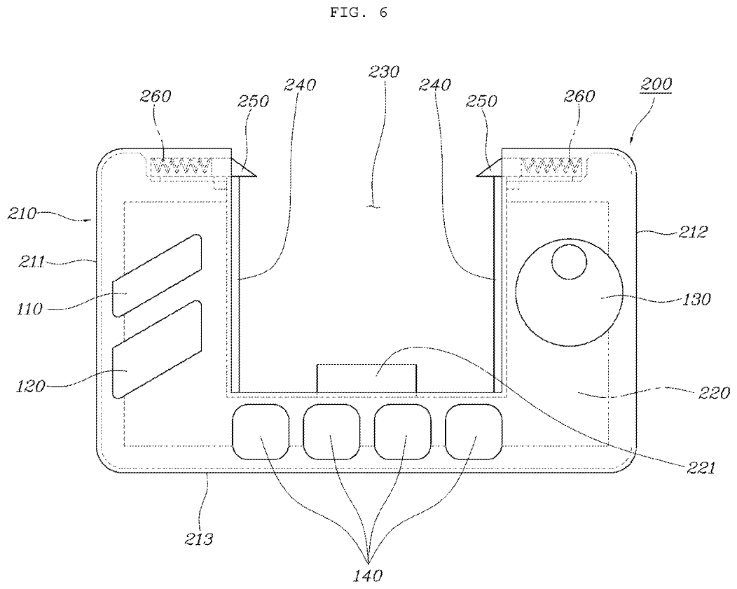

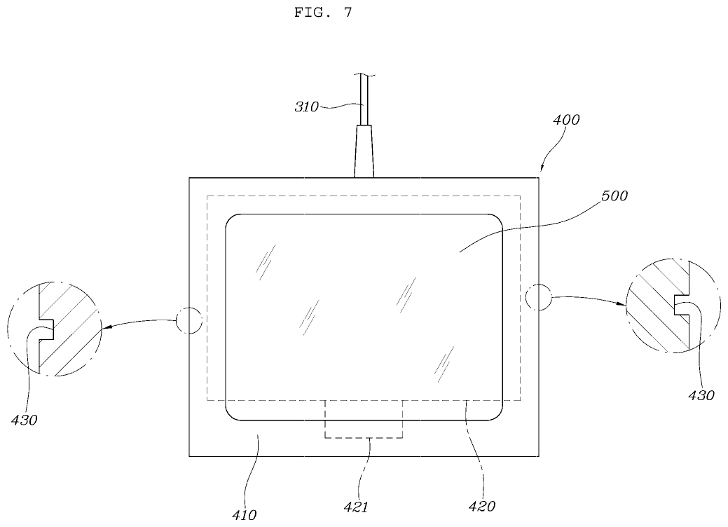

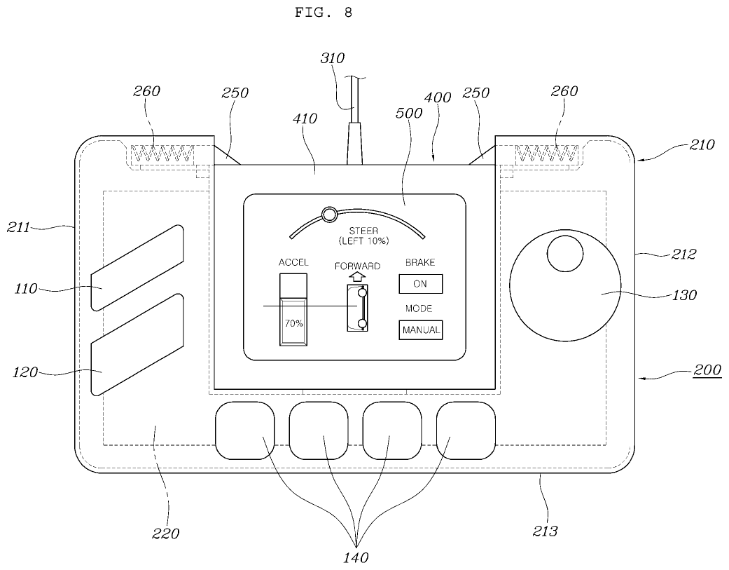

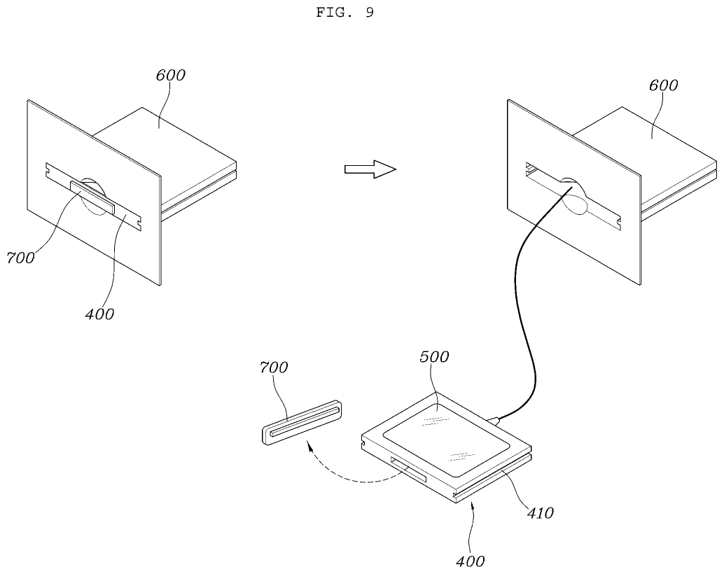

As illustrated in FIG. 1, FIG. 2, FIG. 3, FIG. 4, FIG. 5, FIG. 6, FIG. 7, FIG. 8 and FIG. 9, the integrated control device for an autonomous vehicle according to various exemplary embodiments of the present invention is provided inside an autonomous vehicle 1, and is a device that a vehicle manager may directly operate to drive the vehicle in manual operation mode when an emergency occurs during autonomous driving.

That is, the integrated control device for an autonomous vehicle according to various exemplary embodiments of the present invention may include a mobile control device 10 that a user (e.g., the vehicle manager) operates for the acceleration, braking, steering, and shifting of a vehicle; and a fixed display device 20 provided separately from the mobile control device 10 and configured such that the user operates the fixed display device 20 by touching the surface thereof to operate other functions, except for the acceleration, the deceleration, the steering, and the shifting.

The mobile control device 10 is a device that the user may carry to an intended position for use, whereas the fixed display device 20 is a device fixedly disposed on the cabin of the autonomous vehicle 1.

The other functions activated by operating the fixed display device 20 include a function of operating lamps mounted on the front and rear portions of the vehicle and a function of generating an alarm sound.

The lamps of the vehicle include any type of lamps mounted on the vehicle. Examples thereof may include head lamps, fog lamps, turn signal lamps, rear lamps, warning lamps, and the like.

As components of the mobile control device 10, the integrated control device according to various exemplary embodiments of the present invention may include an operating portion 200 including an acceleration switch 110, a braking switch 120, a steering switch 130, and a shifting switch 140; and a core controller 400 configured to be used in concert with the operating portion 200 and perform control operations to transmit signals of acceleration, braking, steering, and shifting to the vehicle through wiring, e.g., a cable 310 in a response to the switches 110, 120, 130, and 140 provided on the operating portion 200 being operated.

One end portion of the cable 310 is connected to the core controller 400, whereas the other end portion of the cable 310 is connected to actuators provided on the vehicle to implement acceleration, braking, steering, and shifting (or acceleration, braking, steering, and shifting actuators).

The cable 310 is twisted in the shape of a coil spring and is elastic. The length of the cable 310 may be changed due to elastic deformation when external force is applied thereto. The cable 310 may advantageously be stored in a limited space without interfering with other components within the vehicle.

When the user (e.g., the vehicle manager) operates the switches 110, 120, 130, and 140 of the operating portion 200, signals from the operated switches are transferred to the core controller 400. Under the control of the core controller 400, the acceleration, braking, steering, and shifting actuators provided on the vehicle operate to activate the acceleration, braking, steering, and shifting functions of the vehicle.

Thus, embodiments according to various exemplary embodiments of the present invention may advantageously exclude the use of controller area network (CAN) communication units for transferring signals, promoting the simplification of a configuration and the reduction of costs and significantly improving the responsiveness of signals.

According to various exemplary embodiments of the present invention, the operating portion 200 may be provided as a plurality of portions of various types depending on the position and the operating method of the switches 110, 120, 130, and 140, whereas the core controller 400 performing control operations may be provided as a single core controller.

Thus, the user may select a single operating portion 200 according to his or her preference and couple the core controller 400 to the selected operating portion 200 for use. The diversification of the operating portion 200 may advantageously improve the convenience of operation and merchantability.

In the operating portion 200 of the first type illustrated in FIG. 2, the acceleration switch 110, the braking switch 120, and the shifting switch 140 are implemented as button switches and the steering switch 130 is implemented as a dial switch.

The operating portion 200 of the second type illustrated in FIG. 3 is the same as the first-type operating portion 200 illustrated in FIG. 2 in that the acceleration switch 110, the braking switch 120, and the shifting switch 140 are implemented as button switches and the steering switch 130 is implemented as a dial switch, but is characterized in that the positions of the acceleration switch 110 and the braking switch 120 are switched with the position of the steering switch 130 when compared to those illustrated in FIG. 2.

The third-type operating portion 200 illustrated in FIG. 4 is characterized in that the acceleration switch 110 and the braking switch 120 are implemented as button switches, the steering switch 130 is implemented as a lever switch, and the shifting switch 140 is implemented as a toggle switch.

The operating portion 200 may be implemented as a variety of another types depending on the preference of the user, in addition to the above-mentioned first to third types.

The operating portion 200 according to various exemplary embodiments of the present invention may include an operating portion housing 210 to which the acceleration switch 110, the braking switch 120, the steering switch 130, and the shifting switch 140 are coupled; and an operating portion printed circuit board (PCB) 220 provided on the operating portion housing 210 to process signals when the switches 110, 120, 130, and 140 are operated.

The operating portion housing 210 includes one operating portion 211, the other operating portion 212 disposed in parallel to one operating portion 211, and a connecting portion 213 connecting one operating portion 211 and the other operating portion 212.

A docking recess 230 is provided between one operating portion 211 and the other operating portion 212. The docking recess 230 is opened through one side of the operating portion housing 210. Due to the docking recess 230, the operating portion housing 210 including one operating portion 211, the other operating portion 212, and the connecting portion 213 have a ‘U’-shaped structure.

The operating portion housing 210 is configured such that the acceleration switch 110 and the braking switch 120 are disposed on one operating portion 211 of the operating portion housing 210, the steering switch 130 is disposed on the other operating portion 212, and the shifting switch 140 is disposed on the connecting portion 213.

The operating portion housing 210 may be configured such that the steering switch 130 is disposed on one operating portion 211 and the acceleration switch 110 and the braking switch 120 are disposed on the other operating portion 212, depending on the preference of the user.

One operating portion 211 and the other operating portion 212 of the operating portion housing 210 are portions that the user holds with a hand. The acceleration switch 110, the braking switch 120, and the steering switch 130 that are frequently used while driving of the vehicle may be disposed on one operating portion 211 and the other operating portion 212 such that the user may easily use the acceleration switch 110, the braking switch 120, and the steering switch 130.

The core controller 400 includes a core controller housing 410 coupled to the operating portion housing 210 and a core controller PCB 420 connected to the operating portion PCB 220 to process signals from the operated switches 110, 120, 130, and 140.

One end portion of the cable 310 is connected to the core controller PCB 420.

The operating portion 200 and the core controller 400 have a coupled structure, with the core controller housing 410 being inserted into the docking recess 230 formed on the operating portion housing 210.

Guide protrusions 240 are provided on right and left side surfaces of the docking recess 230 formed on the operating portion housing 210 to extend in the longitudinal direction of the side surfaces. Guide grooves 430 are provided on both side surfaces of the core controller housing 410 to extend in the longitudinal direction of the side surfaces such that the guide protrusions 240 are inserted into the guide grooves 430 when the core controller housing 410 is inserted into the docking recess 230.

The guide protrusions 240 and the guide grooves 430 are configured to guide the movement of the core controller 400 when the core controller 400 is coupled to and decoupled from the operating portion 200, and are also configured to prevent the core controller 400 from being dislodged from the operating portion 200 in the top-bottom direction thereof.

Locking guides 250 are provided on the entrance of the docking recess 230 of the operating portion housing 210. The locking guides 250 are supported by return springs 260, respectively. The locking guides 250 are provided as a pair of locking guides 250, and are configured to protrude into the docking recess 230 in opposite directions.

When the insertion of core controller housing 410 into the docking recess 230 is completed, the pair of locking guides 250 may support the rear surface of the core controller housing 410, preventing the core controller housing 410 from being detached from the docking recess 230 in the reverse direction thereof.

The operating portion PCB 220 and the core controller PCB 420 are disposed with connectors 221 and 421 by which the operating portion PCB 220 and the core controller PCB 420 are coupled to each other. Through the connection of the connectors 221 and 421, the operating portion PCB 220 and the core controller PCB 420 may be electrically connected to transfer signals to each other.

In an exemplary embodiment of the present invention, the core controller housing 410 may include an opening 440 and the connectors 221 and 421 are connected to each other through the opening 440.

Embodiments according to various exemplary embodiments of the present invention further include a display 500 provided on the core controller 400 to display information regarding the switches 110, 120, 130, and 140 being operated, information regarding the driving of the vehicle, and the like.

The display 500 is fixed to the core controller housing 410 and is configured such that the operation of the display 500 is controlled by the core controller PCB 420.

When the core controller 400 is detached from the operating portion 200, as illustrated in FIG. 9, the core controller 400 is inserted into and stored in a vehicle-side receptacle 600. During the storage of the core controller 400 in the vehicle-side receptacle 600, a rubber cover 700 remains coupled to the core controller 400.

The rubber cover 700 is configured to protect the connector 421 of the core controller PCB 420, and is detachably coupled to the core controller housing 410.

As described above, the integrated control device for an autonomous vehicle according to various exemplary embodiments of the present invention has a configuration including the operating portion 200 by which the acceleration, braking, steering, and shifting operations are input and the core controller 400 coupled to the operating portion 200 to control the acceleration, braking, steering, and shifting operations. When the user operates the switches 110, 120, 130, and 140 of the operating portion 200, resultant switch signals are transferred to the core controller 400. Under the control of the core controller 400, the acceleration, braking, steering, and shifting actuators located on the vehicle side are operated to perform the acceleration, braking, steering, and shifting functions of the vehicle. Accordingly, the present invention may exclude the use of signal-transferring CAN communication units, advantageously promoting the simplification of the configuration and the reduction of costs and significantly improving the responsiveness of signals.

Furthermore, in the integrated control device according to various exemplary embodiments of the present invention, the operating portion 200 is provided as a plurality of portions of various types depending on the position and the operating method of the switches 110, 120, 130, and 140, whereas the core controller 400 performing the control operations may be provided as a single core controller. Thus, the user may select a single operating portion 200 according to his or her preference and couple the core controller 400 to the selected operating portion 200 for use. The diversification of the operating portion 200 may advantageously improve the convenience of operation and merchantability.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An integrated control device provided on a vehicle to enable a user to operate the vehicle when autonomous driving mode of the vehicle is switched to a manual driving mode of the vehicle, the integrated control device comprising:
an operating portion including an acceleration switch, a braking switch, a steering switch, and a shifting switch; and
a core controller configured to be used in concert with the operating portion and to perform control operations to transmit at least a signal of acceleration, braking, steering, and shifting to the vehicle when at least one of the acceleration switch, the braking switch, the steering switch, and the shifting switch provided on the operating portion is operated.

2. The integrated control device of claim 1, wherein the at least a signal of the acceleration, the braking, the steering, and the shifting is transmitted to the vehicle through wiring.

3. The integrated control device of claim 1,
wherein the operating portion includes a plurality of operating portions of various types depending on positions and operating methods of the acceleration switch, the braking switch, the steering switch, and the shifting switch, and the core controller includes a single core controller, such that the user is allowed to select one operating portion from among the plurality of operating portions and couple the core controller to the selected operating portion for use.

4. The integrated control device of claim 1, wherein each of the acceleration switch and the braking switch includes a button switch, the steering switch includes a dial switch or a lever switch, and the shifting switch includes a button switch or a toggle switch.

5. The integrated control device of claim 1,
wherein the operating portion includes a first operating portion provided on a first side of the integrated control device, a second operating portion disposed provided on a second side of the integrated control device and in parallel to the first operating portion, and a connecting portion connecting the first operating portion and the second operating portion, and
wherein the acceleration switch and the braking switch are disposed on the first operating portion, and the steering switch is disposed on the second operating portion, and the shifting switching is disposed on the connecting portion.

6. The integrated control device of claim 1,
wherein the operating portion includes an operating portion housing to which the acceleration switch, the braking switch, the steering switch, and the shifting switch are coupled and an operating portion printed circuit board (PCB) configured to process the at least a signal from the acceleration switch, the braking switch, the steering switch, and the shifting switch, and
wherein the core controller includes a core controller housing coupled to the operating portion housing and a core controller PCB connected to the operating portion PCB to process the at least a signal.

7. The integrated control device of claim 6,
wherein the core controller housing is selectively coupled to the operating portion housing.

8. The integrated control device of claim 7,
wherein the operating portion housing includes a docking recess opened through a side of the operating portion housing, and
wherein the operating portion and the core controller are coupled to each other, with the core controller housing being inserted into the docking recess.

9. The integrated control device of claim 8,
wherein the operating portion housing further includes guide protrusions provided on first and second side surfaces of the docking recess to extend in longitudinal directions of the first and second side surfaces, and
wherein the core controller housing includes guide grooves provided on first and second side surfaces of the core controller housing to extend in longitudinal directions of the first and second side surfaces of the core controller housing, such that, when the core controller housing is inserted into the docking recess, the guide protrusions are inserted into the guide grooves.

10. The integrated control device of claim 8,
wherein the operating portion housing further includes locking guides provided on an entrance of the docking recess and supported by return springs,
wherein the locking guides include a pair of locking guides and protrude into the docking recess in opposite directions to each other,
wherein, when the insertion of core controller housing into the docking recess is completed, the pair of locking guides supports a rear surface of the core controller housing, preventing the core controller housing from being detached from the docking recess.

11. The integrated control device of claim 7, wherein the operating portion PCB and the core controller PCB include connectors, respectively, by which the operating portion PCB and the core controller PCB are coupled to each other.

12. The integrated control device of claim 11, wherein the core controller housing includes an opening and the connectors of the operating portion PCB and the core controller PCB are connected to each other through the opening.

13. The integrated control device of claim 1, further including a display provided on the core controller to display information regarding the acceleration switch, the braking switch, the steering switch, and the shifting switch being operated and information regarding driving of the vehicle.

14. The integrated control device of claim 1, wherein the core controller detached from the operating portion is configured to be inserted into and stored in a vehicle-side receptacle.

15. The integrated control device of claim 1, wherein the operating portion has a ‘U’-shaped structure, and the core controller is inserted into a recess of the ‘U’- shaped structure to be coupled to the operating portion.
